(19) United States
(12) Patent Application Publication
(10) Pub. No.: US 2011/0106375 A1
(43) Pub. Date: May 5, 2011

(54) METHOD AND SYSTEM FOR PROVIDING AN INTEGRATED PLATFORM FOR ENTERTAINMENT, INFORMATION, COMMUNICATION, CONTROL AND COMPUTING APPLICATIONS IN VEHICLES

(76) Inventor: Vishnu Gurusamy Sundaram, Bangalore (IN)

(21) Appl. No.: 12/980,241

(22) Filed: Dec. 28, 2010

(30) Foreign Application Priority Data
Nov. 3, 2009 (IN) 2665/CHE/2009
Feb. 26, 2010 (IN) 511/CHE/2010

(51) Int. Cl. G06F 17/00

(52) U.S. Cl. 701/33; 701/48; 701/49; 701/36

(57) ABSTRACT

Various embodiments include a method and system for providing an integrated platform for entertainment, information, communication, control and computing applications in a vehicle. The system includes an in-vehicle computer residing in user's vehicle. The in-vehicle computer is used for user's entertainment and transfer of information between user's vehicle and other application servers such as original equipment manufacturers of the vehicle, online stores, toll booths, gas stations, etc. Information transfer and communication can also take place between the user's vehicles and other peer vehicles in its vicinity. The in-vehicle computer can further control vehicles' behavior by utilizing its computing applications and interacting with vehicle's engine, engine controlling unit, air conditioning regulator, speedometer, fuel meter, gyrometer etc. so as to personalize the vehicle according to its user's needs and requirements. The in-vehicle computer also provides a platform to application developers for developing various applications such as games, user identification, GPS, traffic alerts, finger print scanning, voice conferencing social networking, blogging and the likes for the vehicles.

### RELATED APPLICATIONS

The present application claims the benefit of priority of the following: India Patent Application Number 511/CHE/2010, entitled “METHOD AND SYSTEM FOR PROVIDING AN INTEGRATED PLATFORM FOR ENTERTAINMENT, INFORMATION, COMMUNICATION, CONTROL AND COMPUTING APPLICATIONS IN VEHICLES”, filed on Feb. 26, 2010; and India Patent Application Number 2665/CHE/2009, entitled “Method and System for Providing Location Based Service in Communication Network”, filed on Nov. 3, 2009. Each of the aforementioned are hereby incorporated by reference herein for all purposes.

### FIELD

In the field of entertainment and computing platforms for vehicles, a method and system are disclosed for providing an integrated platform for entertainment, information, communication, control and computing applications in a vehicle.

### BACKGROUND

Entertainment platforms and applications such as audio/video player, streaming of media, synchronization of playlists with other media devices like MP3 players etc. have become an integral feature of cars. Further, computational platforms applications like speedometer, determining fuel efficiency, GPS navigator, in-car computing devices etc. have become very common in modern vehicles. However, the existing platforms are very rigid and are restricted to what is provided by the manufacturer, thus preventing customization of a vehicle based on requirements and needs of a user. Further, different vehicle manufacturers provide different entertainment and computational platforms which are usually not compatible with vehicles manufactured by others; hence a user cannot implement all the desirable features and applications available in the market in a single vehicle.

Moreover, there are discrete components of computing elements in a vehicle such as central locking, power windows, air-conditioning controls, audio controls, video player, internet on other computing gadgets such as mobile phones, rear camera, etc. These components when working separately, offer just only their specific functionalities, but when converged, they open up immense possibilities for building applications which can result in new services, applications and new levels of comfort and personalization to the users.

Therefore there is a need for a method and a system for enabling a platform which integrates various discrete entertainment and computing applications in a vehicle, thereby allowing greater personalization and customization of the vehicle as per the requirements and needs of a user.

Different geographies have different physical conditions like roads, climate, heat, etc. and a vehicle's adaptability to different terrains is very important for its efficient functioning. However such data related to performance of vehicles in different terrains, climate, heat etc. is not readily available to manufactures, thus resulting in manufacturing gaps. Further user specific data e.g. speed, pattern of driving, fuel efficiency, frequency of servicing of the vehicle are not readily available. This gap may be filled by availability of data for different terrains across different geographies, different usage patterns, response of different systems in the vehicle etc.

Therefore there is a need for a method and system for a computing platform which provides vehicle behavior in real time or in store and forward fashion to the vehicle manufacturers, thus helping them in designing and developing better vehicles to cater to the requirements across different geographies and users.

Nowadays, application builders concentrate on building applications such as games, social networking applications, video chatting, GPS services and the likes for mobiles, PDAs, gaming consoles, computers etc. but no application specific to vehicles are being developed. This is due to the lack of a standard platform for which applications may be built and lack of any standardized support for adding applications to existing system.

Therefore, there is a need for a standardized integrated application platform in vehicles for which various applications may be developed, thus opening up a vast market for such application developers.

### BRIEF DESCRIPTIONS OF DRAWINGS

FIG. 1 is a schematic illustrating an in-vehicle integrated application platform environment in accordance with various embodiments; and

FIG. 2 is a schematic illustrating an in-vehicle integrated application platform in accordance with various embodiments.

### DESCRIPTION OF EMBODIMENTS

In the following description, for the purposes of explanation, specific details are set forth in order to provide a thorough understanding of various embodiments. However, it will be apparent that various embodiments may be practiced without these specific details. Various aspects and features of example embodiments are described in more detail hereinafter.

Various embodiments or any components thereof may take the form of a processing machine. Typical examples of a processing machine include a computer, a programmed microprocessor, an integrated circuit, and other devices or arrangements of devices that are capable of implementing the steps of the methods according to various embodiments. The processing machine executes a set of instructions that are stored in one or more storage elements, in order to process input data. The storage elements may also hold data or other information as desired. The storage element may be in the form of an information destination or a physical memory element present in the processing machine. The set of instructions may include various commands that instruct the processing machine to perform specific tasks such as the steps that constitute methods according to various embodiments. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine. A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the internet or any client server models that enable communication. Such communication technologies may use various protocols such as TCP/IP, UDP, ATM or OSI.

Methods and systems for providing an integrated platform for entertainment, information, communication, control and computing applications in a vehicle are disclosed.

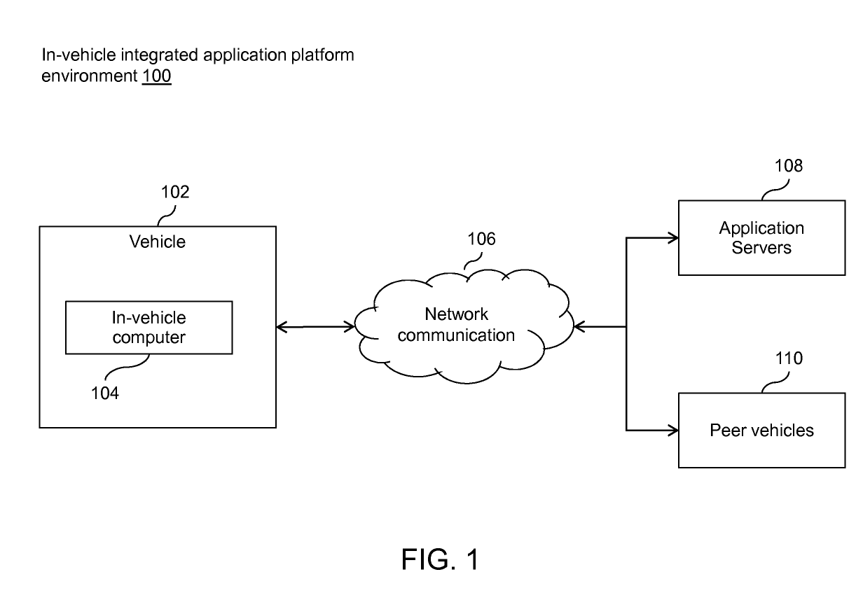

FIG. 1 is a schematic illustrating in-vehicle integrated application platform environment 100 in accordance with various embodiments. In-vehicle computing and entertainment platform environment 100 includes vehicle 102, in-vehicle computer 104, network communication 106, application servers 108 and peer vehicles 110.

Vehicle 102 is a conveyance medium including but not limited to cars, trucks, vans, helicopters, flights, space shuttles and the like. For illustrative purposes, vehicle 102 is described as a four-wheeler vehicle, however this should not be considered as a limitation. Various embodiments may also be applied to other vehicle types such as helicopters, flights, space shuttle and the likes which are well within the scope of the contemplated embodiments.

Vehicle 102 provides housing to in-vehicle computer 104. In-vehicle computer 104 may be a dash board mounted computer and may be fitted in audio bays including but not limited to 1 DIN and 2 DIN in existing vehicles. As used herein, DIN refers to an industry standard criterion for the inside size in a car for placing and installing a car stereo system. In-vehicle computer 104 has computing, data processing and networking capabilities and has access to various computing and control devices in vehicle 102. Such computing and controlling devices may include but are not limited to speedometer, fuel meter, air-conditioning regulator, engine control units, gyrometer and the like. By accessing these computing and control devices in vehicle 102, in-vehicle computer 104 may control vehicle 102's behavior to personalize the vehicle according to its user's needs and requirements. Further, in-vehicle computer 104, by taking inputs from vehicle 102's gyrometer, may adjust vehicle 102's behavior to enhance comfort of the user and warn the user about the road conditions. User of vehicle 102 may be a driver or a passenger of vehicle 102. In some embodiments, in-vehicle computer 104 receives and uses inputs from various data sources external to vehicle 102 in order to provide services to the user and also make control decisions for vehicle 102. For example in-vehicle computer 104 uses location source as one of the inputs to identify the road and area in which vehicle 102 is and then use this information to fetch the speed limit of that particular road dynamically. The fetched speed limit is then conveyed to the user and the user is provided alerts on over speeding occasions.

In-vehicle computer 104 enables the setting of different usage profiles for different users, exposing one user to a set of features of vehicle 102 and another other user with a different set of features. The features corresponding to a usage profile may include without limitation, vehicle 102's speed, air-conditioning, volume of speakers, and the like. For example, suppose vehicle 102 is used by two different drivers, namely D1 and D2. Now suppose D1 is very experienced in driving and can effortlessly control vehicle 102 at high speeds, however D2 is learning to drive and thus should not drive at higher speeds. In order to ensure that D2 does not drive beyond a certain specified speed, say 60 km/hr, D1 can define settings of vehicle 102 such that vehicle 102 identifies the driver and allows different speed limits for different drivers. In this case, the speed limit for D2 will be set as 60 km/hr in in-vehicle computer 104 and for D1 there will be no speed limit. Therefore vehicle 102 is personalized based on the user of vehicle 102. Similarly various other settings may be defined by the user to personalize vehicle 102 for user's specific needs and requirements.

In various embodiments, if a user attempts to go outside the bounds of certain settings (e.g., if user D1 attempts to exceed a maximum speed limit that has been set for him), the vehicle may respond. The vehicle's response may include one or more of the following: (a) preventing the user from going outside the bounds (e.g., preventing the user from exceeding a specified speed limit); (b) alerting the user that he is attempting to go (or is going) outside the bounds (e.g., with an alarm or a computer voice alert); (c) alert a third party about the user's actions (e.g., alert a parent of the user; e.g., alert authorities); (d) penalizing the user in some way (e.g., denying access for the user to a preferred radio station).

Further, in various embodiments, the user is identified by in-vehicle computer 104 through visual recognition using a camera, voice recognition, finger print identification etc. and user's profile is automatically enabled in vehicle 102. For example, the user is identified by in-vehicle computer 104 as soon as the user sits in vehicle 102 and keeps his/her hand on the steering, a finger-print sensor mounted on the steering wheel identifies the user and user's predefined usage profile is enabled. The user's profile may also be maintained online thus enabling the user to access his/her usage profile in different vehicles 102. In an embodiment, in-vehicle computer 104 builds user's usage profile based on previous usage data stored with in-vehicle computer.

Further, in-vehicle computer 104 may act as a platform on which various applications for and related to games, network games, GPS navigations, video conferencing, social networking, driver identification by finger print reading or visual confirmation, fuel efficiency calculator, location based services, news feeds and the likes may be developed. In-vehicle computer 104 further supports various commercial activities including without limitation buying of media from online music/video stores, creating audio/video content and putting it up for sale, paying tolls at toll booths, paying for fuel at fuel stations, pushing sponsored advertisements to user based on user preferences and various subscription models etc. For example, usage of GPS by the user may be charged based on pay per km, pay per destination, pay per duration of use model and the likes and payments for such services may be made through in-vehicle computer 104.

In-vehicle computer 104 may further act as a black box for vehicle 102 as it records all the inputs related to vehicle 102 and user's driving patterns. These inputs include without limitation audio and video feeds of the user while using vehicle 102, driving characteristics of the user such as speed and the likes. In an embodiment these inputs are stored in a remote storage system. These inputs may further act as evidences and provide vital information about any catastrophic event such as accidents, sand storms, etc. Further, these inputs may also be transmitted in real-time to various monitoring agencies which may then provide assistance, control, information or services to the user and external agencies such as road transport authorities etc. For example in case of over speeding of vehicle 102, the monitoring agency could alert the road transport authorities to levy a fine on the user.

Various operating systems such as Google Android, Linux, Windows Vista, Windows 7 and the likes may be used in in-vehicle computer 104. Network communication 106 enables in-vehicle computer 104 to communicate with application servers 108 and peer vehicles 110. Network communication 106 includes without limitation, wi-fi, Bluetooth, internet, GSM, GPS, radio frequency communication, WiMax, wired communication through USB, DVI and the likes.

Application servers 108 include but are not limited to servers of original equipment manufacturers (OEM) of vehicle 102, online media libraries, traffic surveillance systems, advertisement providers, toll booths, gas stations, social networking services and the likes. Examples of online media libraries include but are not limited to online book stores, online music stores and the likes. In an embodiment, in-vehicle computer 104 may further act as application server 108 providing services to other compatible systems.

Peer vehicles 110 are cars and other transportation vehicles with which are in the vicinity of vehicle 102. Vehicle 102 is capable of interacting with peer vehicles 110 to enable the communication and data transfer. In an embodiment, the user of vehicle 102 may communicate with passengers of peer vehicles 110 by video conferencing, voice call, text messages, alerts, greetings, games etc. Further, in another embodiment, in-vehicle computer 104 enables communication and transfer of information to and from peer vehicles 110 such as car position, speed, traffic alerts etc.

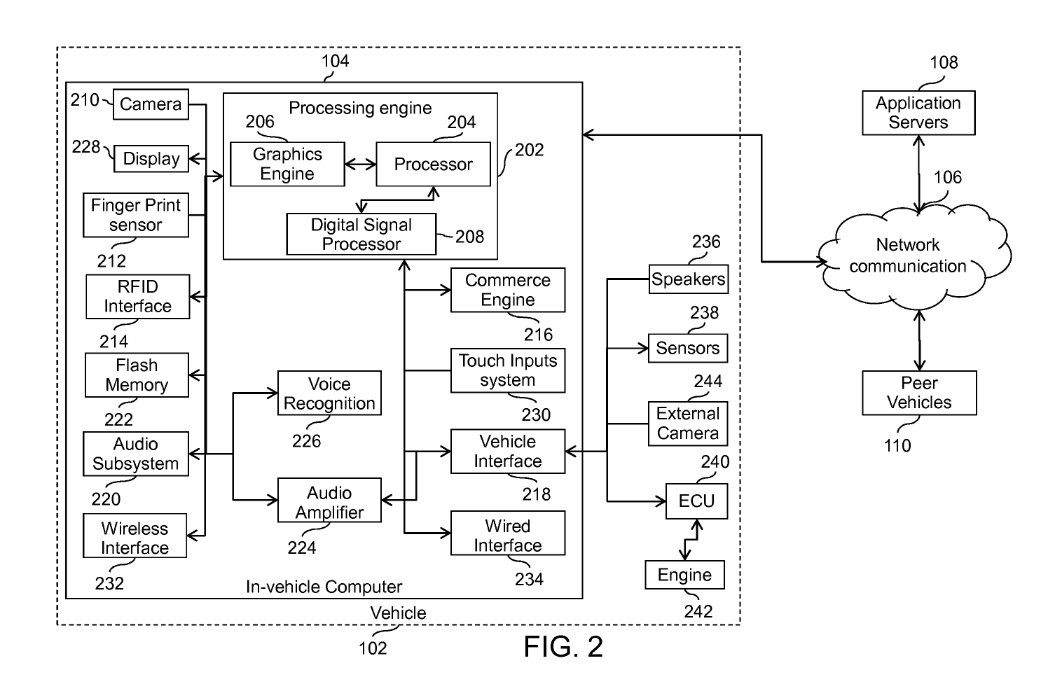

FIG. 2 is a schematic illustrating an in-vehicle integrated application platform in accordance with various embodiments. The in-vehicle integrated application platform comprises in-vehicle computer 104 and its connections with vehicle 102.

In-vehicle computer 104 includes processing engine 202, camera 210, finger print sensor 212, RFID interface 214, commerce engine 216, vehicle interface 218, audio subsystem 220, flash memory 222, audio amplifier 224, voice recognition 226, display 228, touch inputs 230, wireless interface 232 and wired interface 234. Processing engine 202 further includes processor 204, graphics engine 206 and digital signal processor 208. Vehicle 102 includes speakers 236, sensors 238, ECU (engine control unit) 240, engine 242 and external camera 244 which interact with in-vehicle computer 104.

Processor 204 is a central processing unit (CPU) which runs software and provides interfaces between hardware and software. Processor 204 runs logical, arithmetic and other operations which help in running in-vehicle computer 104. Examples of processor 204 are TI AM3517, OMAP 3530, Intel XScale, Intel Atom, etc. Processor 204 is coupled with various memory and storage devices for storing software stack including all programs, applications, software etc. which in-vehicle computer 104 may run. The software stack provides ready platform to software developers who may then implement their algorithms to the existing software stack for developing new applications, thereby removing overhead of the software developers as they do not require the understanding of complexities involved in building applications for vehicles. Since all the basic functions and methods required for application development are exposed to the developers by the software stack, this further shortens the development cycle of an application.

Apart from providing existing methods, software stack also handles application security, rights management, copy protection, security against virus attacks etc. The application programs stored in the secured layers have controlled access. Further, a security application may run on in-vehicle computer 104 to supervise and monitor the functioning of all other applications.

Graphics engine 206 may work in tandem with processor 204 and may handle some or all the graphics rendering, encoding, decoding and mathematical functions so as to minimize the load on processor 204 in handling all the graphical operations. Graphics engine 206 enables processor 204 to provide high throughput in terms of video, audio and image processing. Examples of graphics engine 206 are POWERVR SGX™ Graphics Accelerator, Nvidia accelerator, etc. Digital signal processors 208 may work in tandem with processor 204 and may handle specific computational functions. Since digital signal processors 208 perform a specific function and therefore aid in better performance of the system in functions such as computation, rendering video, audio, etc. Examples of digital signal processors 208 are NEON SIMD Coprocessor, Vector floating point (FP) co-processor etc.

Camera 210 is interfaced to processor 204 and provides visual input to processor 204. Camera 210 is a type of CMOS, CCD or other imaging sensors. Camera 210 may be optimally used in low light conditions as ambient light in vehicle 102 is generally low. Camera 210 enables the user to have video conferencing and video calls. Inputs provided by camera 210 to processor 204 include without limitation, driver identification, driver status while driving vehicle 102 and the likes. For example, in case the driver is sleepy-eyed, camera 210 provides the inputs about driver's driving status to processor 204 and processor 204 may provide an alert to the driver to ensure safety of both the driver and the vehicle. Camera 210 enables live video capturing of the user, enabling in-vehicle computer 104 to recognize gestures and user's moods and provide entertainment such as music, movies, advertisements, games etc. based on the identified gestures and moods.

Finger print sensor 212 provides user authentication input to processor 204. Finger print sensor 212 may be based on technologies such as capacitive, resistive, RF (radio frequency) etc. Further, finger print sensors 212 may be swipe or scan sensors, which are capable of weeding out dead fingers, and handling grease and other harsh operating conditions. AES1711 is an example of finger print sensor 212.

RFID (radio frequency identification) interface 214 enables in-vehicle computer 104 to detect and identify RFID enabled objects inside vehicle 102 including but not limited to mobile phones, keys, wallet etc. Further, based on inputs from RFID interface 214, in-vehicle computer 104 provides alerts and messages to the user. For example in case the user has left his/her mobile phone in vehicle 102, in-vehicle computer 104 detects and identifies user's mobile phone via RFID interface 214 and alerts the user through audio signals or messaging him through any of the available communication network. Example of RFID interface 214 include without limitation NXP CL RC632.

Commerce engine 216 utilizes various identification inputs from sensors including camera 210, RFID interface 214 etc. for authenticating transactions and interfacing with payment gateways and order fulfillment entities. For example in case the user wants to buy music from online music store though in-vehicle computer 104, the order confirmation will go through commerce engine 216, which after authenticating user's identity from input by camera 210 or finger print sensor 212 or through any other input sources available to in-vehicle computer 104, processes the order.

Vehicle interface 218 acts as an interface between in-vehicle computer 104 and other computing systems which exist on vehicle 102. In an embodiment, the interfacing may be through standard protocols such as OBD (on board diagnostics) or CAN (controlled area network) or any other proprietary or non proprietary protocols.

Audio subsystem 220 handles audio related processing including mike and speaker processing. Audio subsystem 220 is capable of handling several sources of input and output, decoding digital audio, multichannel sound, etc. Further, audio subsystem 220 enables in-vehicle computer 104 to recognize the user and his/her commands for providing personalized features and services to the user. Examples of audio subsystem 220 include without limitation TI Aureus™ High Performance Digital Audio Processors and Intersil D2 audio subsystem.

Flash memory 222 is a non volatile memory which may be used by in-vehicle computer 104 for storing booting codes, operating system, applications and other data associated with in-vehicle computer 104 including music, movies, maps, GPS data, logged data from vehicle 102, results of statistical analysis conducted by in-vehicle computer 104, etc.

Audio amplifier 224 receives input from mikes and speakers and amplifies the inputs using power amplifiers to feed large speakers, woofers, tweeters, buzzers and other audio elements in vehicle 102. Examples of audio amplifier include without limitation Intersil Class D amplifier. Voice recognition 226 uses mike input from sensors and recognizes the user and his/her commands for in-vehicle computer 104, making user communication with in-vehicle computer 104 interactive. Display 228 provides visual output of in-vehicle computer 104 to the user. Example of display 228 includes without limitation a 7″ 840×480 pixels TFT display unit. Touch inputs system 230 receives touch inputs from the user. The touch inputs are correlated to pixels and exact touch points are identified, processing is then applied on to the touch position to correct any errors and for using the touch position for providing user input to in-vehicle computer 104. Touch inputs system 230 may be integrated with display 228 by using a touch screen. Further touch inputs systems 230 may also be placed on top of steering wheel, dashboard, seats, doors, instrument cluster, external door handles, etc of vehicle 102.

Wireless interface 232 includes without limitation GPS, GSM, Wi-Fi, WiMax, Bluetooth, radio frequency systems. GPS (global positioning system) uses satellite to triangulate the location of vehicle 102. Here the location triangulation is not limited to GPS, and inputs from other location systems may also be used to approximate the location of vehicle 102. GSM (global system for mobile) enables in-vehicle computer 104 to interact with the connected internet world while on the move to provide services to the user such as voice calls, video calls, data calls, fax messages, internet, email, instant messaging, social blogging, controlling external machines, etc. In an embodiment, Wi-Fi communication is used to enable in-vehicle computer 104 to communicate with other networked computing devices such as laptops, desktops etc. for synchronizing information between in-vehicle computer 104 and user devices. For example, in case the user's vehicle 102 is nearby his/her house which has user's desktop, in-vehicle computer 104 on detecting the desktop through Wi-Fi technology will synchronize the music files of the desktop with in-vehicle computer 104's memory, therefore enabling the user to listen to his/her favorite music while driving. WiMax provides long range broadband internet connectivity to in-vehicle computer 104 therefore enabling the user to use high bandwidth applications inside vehicle 102. Further, data may also be transferred to OEM servers from vehicle 102. For example, data such as performance of vehicle 102 in different terrains, fuel efficiency of vehicle 102, volume at which user likes to hear music; usage of GPS by the user and the likes is sent to the OEM servers which may then analyze the data to develop new products or product improvements. Bluetooth connectivity of in-vehicle computer 104 enables it to establish short range communication links with laptops, mobile phones etc. present inside vehicle 102. Further, any other means of communication such as radio frequency, UHF (ultra high frequency), VHF (very high frequency) etc. may be used by in-vehicle computer 104 to establish communication with the internet, connected world, peer vehicles 110 and other computing units. Wireless interface 232 enables remote monitoring of vehicle 102, providing traffic alerts and suggestions for driving to the user. Further, in-vehicle computer 104 communicates with other wired and wireless enabled devices such as mobile phone, laptop etc. and synchronizes data with these devices. In an embodiment, mobile phone of the user may act as a remote control for in-vehicle computer 104. For example, the user can modify his/her driving profile such as speed limits, air-conditioning, volume of speaker etc. by using mobile phone as a remote control for in-vehicle computer. In another embodiment, in-vehicle computer 104 may also act as a remote control for user's mobile.

Wired interface 234 enables in-vehicle computer 104 to communicate with other systems and devices by physically connecting the devices with in-vehicle computer 104. Examples of wired interface 234 include without limitation USB, serial, DVI etc. Speakers 236 reside in vehicle 102 and convert audio from analog to sound energy. In an embodiment, speakers 236 are connected to in-vehicle computer 104 via vehicle interface 218.

Sensors 238 reside in vehicle 102 and include without limitation fuel level sensor, door open close sensor, knock sensor, flat tire sensor, etc. Sensors 238 are connected to processing engine 202 via vehicle interface 218. ECU 240 controls and monitors engine 242 and other components of vehicle 102 which interact with engine 242. ECU 240's OBD and CAN interfaces are used by in-vehicle computer to connect to ECU 240. By interacting with ECU 240, in-vehicle computer 104 may also control vehicle 102 in a similar manner as auto pilot mode for flights by making decisions based on information gathered through various communication mediums such as traffic surveillance, peer vehicles 110, condition of roads, speed limits for different roads etc.

Engine 242 is a set of components or parts which work together in propelling vehicle 102. Examples of engine 242 include without limitation internal combustion engine, electric engine, etc. Engine 242 is connected to in-vehicle computer 104 via vehicle interface 218. The connection between engine 242 and in-vehicle computer 104 enables in-vehicle computer 104 to gather information related to engine 242 such as engine efficiency, engine heating, fuel efficiency etc. This information may then be used by OEMs to modify and develop new engines 242.

External camera 244 is placed in the periphery of vehicle 102 or in locations external to vehicle 102, and is used for providing driving assistance, threat detection on the road and other related services to the user.

The following are embodiments, not claims:

In various embodiments, a vehicle includes a software platform for controlling the vehicle. The platform may serve as an operating system.
E. A set of computer instructions that are capable of execution by a processor embedded in a vehicle, and, when executed cause such processor to:

run a first application program;

generate, from the first application program, commands to modify the state of the vehicle;

effectuate, in response to said commands, a modification of a climate system of the vehicle;

effectuate, in response to said commands, a modification of a radio system of the vehicle;

effectuate, in response to said commands, a modification of an entertainment system of the vehicle;

effectuate, in response to said commands, a modification of a seat positioning system of the vehicle;

effectuate, in response to said commands, a modification of a climate system of the vehicle;

effectuate, in response to said commands, a modification of a speed of the vehicle;

effectuate, in response to said commands, a modification of a lighting system of the vehicle; and

effectuate, in response to said commands, a modification of a navigation system of the vehicle.

In some embodiments, a user can download an application program.
E.4 The set of computer instructions of embodiment E that, when executed, further cause such processor to download the first application program.
E.4.1 The set of computer instructions of embodiment E.4 that, when executed, further cause such processor to download the first application program from one of: (a) the Internet; (b) a portable storage device; (c) a mobile computing device; (d) a cellular phone; (e) a tablet personal computer; (f) a laptop computer; (g) a personal digital assistant; and (h) another vehicle.
In some embodiments, a user chooses the application program to download.
E.4.2 The set of computer instructions of embodiment E that, when executed, further cause such processor to:

receive from a user an indication of the first application program, in which the processor downloads the first application program in response to the indication.

In some embodiments, the operating systems is like a desktop, displaying indications of applications, and allowing the user to click on them or download more.
E.3 The set of computer instructions of embodiment E that, when executed, further cause such processor to:

instruct a display screen in the vehicle to display an icon representing the first application program;

instruct the display screen in the vehicle to display an icon representing a second application program;

detect a user input;

pass the user input to the first application program.

E.3.1 The set of computer instructions of embodiment E, in which, when causing the processor to detect a user input, cause the processor to:

receive an indication of a user input via at least one of a: (a) touch pad; (b) touch-sensitive display screen; (c) microphone; and (d) camera.

E.3.2 The set of computer instructions of embodiment E, that, when executed, further cause such processor to:

receive an output from the application program; and

instruct the display screen to display the output.

E.1 The set of computer instructions of embodiment E, in which, in causing the processor to modify a navigation system of the vehicle, the computer instructions cause the processor to:

effectuate, in response to said commands, a modification of a system of the vehicle for recommending driving routes.

In some embodiments, an application program may come from another vehicle.
E.2 The set of computer instructions of embodiment E in which, when executed, the instructions further cause the processor to:

receive the first application program from another vehicle.

In some embodiments, an application program may come from the user. For example, the user may carry a cell phone or USB stick that can download an application program to his vehicle.
E.2 The set of computer instructions of embodiment E in which, when executed, the instructions further cause the processor to:

receive the first application program from a device of a user.

In some embodiments, a vehicle may alert a user if a user has left a device in the vehicle. For example, the vehicle may alert the user if he has left a mobile phone in the vehicle. The vehicle may sense the presence of the mobile phone via RFID, for example. The vehicle may alert the user through sounding a horn, an alarm, or some other audio output, or through flashing lights or providing some other visual output.
C. A vehicle comprising:

a sensor;

a control system operable to receive electronic signals and actuate systems of the vehicle based on the received electronic signals;

a computer readable medium containing computer code;

a processor operable to execute the computer code to:
determine that a user is not present in the vehicle;
receive via the sensor a signal indicative of the presence of a user device; and
provide instructions to the control system to cause an alert to be generated.
   C.1 The vehicle of embodiment C in which the sensor is a radio frequency identification sensor, and in which the processor is operable to receive via the sensor a radio frequency signal from the user device.
   In some embodiments, an alert may take the form of a horn being sounded.
   C.2 The vehicle of embodiment C in which, in providing instructions, the processor is operable to provide instructions to the control system to cause a horn of the vehicle to be sounded.
   C.3 The vehicle of embodiment C in which the alert is at least one of: (a) a horn sounding; (b) a bell chiming; (c) an alarm sounding; (d) a headlight lighting; (e) a headlight flashing; and (f) a light flashing.
   In various embodiments, an in-vehicle computer acts as an application server providing services to other compatible systems, e.g., peer vehicles in the vicinity.
   B. A first vehicle comprising:

a sensor;

a control system operable to receive electronic signals and actuate systems of the first vehicle based on the received electronic signals;

a computer readable medium containing computer code;

a processor operable to execute the computer code to:
initiate communication with a second vehicle that is within a predetermined distance of the first vehicle;
receive a request from the second vehicle to execute an application;
receive from the second vehicle parameters for the application;
execute the requested application using the received parameters; and
provide an output of the application to the external vehicle.
   In some embodiments, a vehicle can act as a web server for nearby vehicles.
   B.1 The vehicle of embodiment B in which the application is a web server, the parameter is a uniform resource locator, and in which the output is a Web page associated with the uniform resource locator.
   A. A vehicle comprising:

a sensor;

a control system operable to receive electronic signals and actuate systems of the vehicle based on the received electronic signals;

a computer readable medium containing computer code;

a processor operable to execute the computer code to:
receive first information about a first user in the vehicle;
determine a first identity of the first user based on the received first information;
determine a first setting associated with the first identity, in which the first setting is a setting of a system of the vehicle; and
issue instructions to effectuate the first setting in the vehicle.
   In some embodiments, a vehicle may include or may form part of a commerce engine. The vehicle may allow the user to engage in commercial transactions. In the commercial transactions, the user's identity may be authenticated by the vehicle.
   A.7 The vehicle of embodiment A in which the processor is further operable to:

receive from the first user an indication of a desire to enter a transaction with a counterparty;

receive from a counterparty a request to confirm the first identity of the first user; and

provide to the counterparty an indication that the first identity has been confirmed based on the first information.

A.7.1 The vehicle of embodiment A.7 in which the processor is further operable to:

provide to the first user an indication that the counterparty has agreed to the transaction; and

provide to the counterparty an indication that the first user has agreed to the transaction.

In some embodiments, a set of preferences about a user can be retrieved from a network and/or from an external device. A user's preferences may then be recognized across multiple vehicles, for example.
A.6 The vehicle of embodiment A, in which the processor is further operable to receive an indication of a set of preferences associated with the first user, in which the first setting is included among the set of preferences.
A.6.1 The vehicle of embodiment A in which the set of preferences is received from another vehicle.
A.6.2 The vehicle of embodiment A in which the set of preferences is received over a network.
A.6.3 The vehicle of embodiment A in which the set of preferences is received from an external device.
A.6.4 The vehicle of embodiment A in which the set of preferences is received from a mobile communications device.
In some embodiments, the vehicle may recognize the identities of multiple users, and may effectuate vehicle settings that are personalized to each user. For example, a vehicle may tailor vehicle settings to either of a first and a second user.
A.5 The vehicle of embodiment A in which the processor is further operable to:

receive second information about a second user in the vehicle;

determine a second identity of the second user based on the received second information;

determine a second setting associated with the second identity, in which the second setting is a setting of a system of the vehicle; and

issue instructions to effectuate the second setting in the vehicle.

A.5.1 The vehicle of embodiment A.5 in which the first setting is not the same as the second setting.
A.1 The vehicle of embodiment A in which, in receiving first information about the first user, the processor is operable to receive biometric information about the first user.
A.1.1 The vehicle of embodiment A.1 in which the biometric information includes one of: (a) a fingerprint reading; (b) a picture; (c) a retinal scan; (d) a voice recording; (e) a weight; (f) a height; (g) an eye color; and (h) a hair color.
In various embodiments, a setting may include an internal temperature of the vehicle.
A.2 The vehicle of embodiment A further including a climate control system, in which the first setting is a temperature, and in which, in issuing instructions, the processor is operable to issue instructions for the climate control system to bring the interior of the vehicle to the temperature.
In various embodiments, a setting may include a radio station.
A.3 The vehicle of embodiment A further including a radio, in which the first setting is a radio station, and in which, in issuing instructions, the processor is operable to issue instructions for the radio to tune to the radio station.
In various embodiments, a setting may include a seat position, e.g., of the driver's seat.
A.4 The vehicle of embodiment A further including a seat, in which the first setting is a seat position, and in which, in issuing instructions, the processor is operable to issue instructions for the seat to move to the seat position.
In some embodiments, there may be up to four ways to receive commands from a user.
F. A vehicle comprising:

a microphone;

a camera;

a display screen that is touch sensitive;

a steering wheel with a touch pad;

a control system operable to receive electronic signals and actuate systems of the vehicle based on the received electronic signals;

a computer readable medium containing computer code;

a processor operable to execute the computer code to:
receive a first spoken command from a user via the microphone;
receive a second gestured command from the user via the camera;
receive a third command from the user via the display screen that is touch sensitive;
receive a fourth command from the user via the touch pad; and
issue instructions to effectuate at least one setting in the vehicle based on the received first, second, third, and fourth commands.
   In some embodiments, there may be a conflict in the commands. One may take precedence over the other.
   F.2 The vehicle of embodiment F in which the processor is further operable to:

determine that there is a conflict between two of the received commands; and

determine a highest priority command from among the conflicting commands,

in which, in issuing instructions, the processor is operable to effectuate at least one setting in the vehicle based only on the highest priority command from among the conflicting commands.

In some embodiments, a mute button or explicit indication by the user may point to which commands have highest priority.
F.2.1 The vehicle of embodiment F.2 in which the processor is further operable to receive from the user an indication to reduce the priority of any commands received via a particular sensor,

in which, in determining a highest priority command, the processor is operable to determine a command from among the conflicting commands that has not been received via the particular sensor.

F.2.1.1 The vehicle of embodiment F.2.1 in which the processor is further operable to receive from the user an indication to mute the microphone,

in which, in determining a highest priority command, the processor is operable to determine a command from among the conflicting commands that has not been received via the microphone.

In some embodiments, external conditions may dictate which commands are followed. For example, touch screen display may be disabled if there are bad road conditions and it would be dangerous for the user to take his eyes off the road to touch the screen.
F.2.2 The vehicle of embodiment F.2 in which the processor is further operable to:

receive an indication of current driving conditions; and

determine, based on the indication of current driving conditions, that any commands received via a particular sensor will have reduced priority,

in which, in determining a highest priority command, the processor is operable to determine a command from among the conflicting commands that has not been received via the particular sensor.

F.2.2.1 The vehicle of embodiment F.2 in which, in receiving an indication of current driving conditions, the processor is operable to receive an indication of poor visibility, and in which the particular sensor is the display screen that is touch sensitive.
In some embodiments, the vehicle may determine gestured commands through gesture-recognition algorithms performed on captured video.
F.1 The vehicle of embodiment F in which, in receiving the second gestured command, the processor is operable to:

receive a video of the user captured by the camera;

determine the second gestured command by performing a gesture-recognition algorithm on the video.

In some embodiments, commands are received from multiple users.
G. A vehicle comprising:

a first sensor proximate to a driver's seat;

a second sensor proximate to a passenger's seat;

a control system operable to receive electronic signals and actuate systems of the vehicle based on the received electronic signals;

a computer readable medium containing computer code;

a processor operable to execute the computer code to:
receive a first command from the driver via the first sensor;
receive a second command from the passenger via the second sensor; and
issue instructions to effectuate a first setting in the vehicle based on the received first command; and
issue instructions to effectuate a second setting in the vehicle based on the received second command.
   G.1 The vehicle of embodiment G in which the first sensor is a first microphone, and the second sensor is a second microphone.
   G.2 The vehicle of embodiment G in which the first sensor is a first camera, and the second sensor is a second camera.
   In some embodiments, a sensor trained on one vehicle occupant is set to ignore another vehicle occupant.
   G.2 The vehicle of embodiment G in which the processor is further operable to execute computer code to:

receive a third command from the passenger via the first sensor;

determine that the third command has not originated from the driver; and

disregard the third command based on the determination that it did not originate from the driver.

In some embodiments, there may be various ways for the processor to determine where a command has come from. In some embodiments, if audio has not come from nearby, then the associated command may be ignored.
G.2.1 The vehicle of embodiment G.2 in which, in determining that the third command has not originated from the driver, the processor is operable to determine that audio constituting the third command has originated from a source not proximate to the first sensor.
In various embodiments, the origin of a command can be determined by voice profile.
G.2.2 The vehicle of embodiment G.2 in which, in determining that the third command has not originated from the driver, the processor is operable to:

load a voice profile of the driver;

compare audio constituting the third command to the voice profile; and

determine that the audio does not match the voice profile.

In various embodiments, a vehicle may receive commands from multiple users simultaneously, and respond to such commands simultaneously and independently.
G.3 The vehicle of embodiment G in which the first and second commands are received substantially simultaneously.
G.4 The vehicle of embodiment G in which instructions to effectuate the first setting, and instructions to effectuate the second setting are issued substantially simultaneously.
G.5 The vehicle of embodiment G in which the first setting and the second setting are effectuated simultaneously.
G.6 The vehicle of embodiment G in which the first setting and the second setting are effectuated independently of one another.
In some embodiments, there may be up to four ways to receive commands from a user.
FG. The vehicle of claim G further including:

a third sensor comprising a microphone;

a fourth sensor comprising a camera;

a fifth sensor comprising a display screen that is touch sensitive; and

a steering wheel with a sixth sensor comprising a touch pad,

in which, in executing the computer code, the processor is further operable to:
receive a third spoken command from a user via the microphone;
receive a fourth gestured command from the user via the camera;
receive a fifth command from the user via the display screen that is touch sensitive;
receive a sixth command from the user via the touch pad; and
issue instructions to effectuate at least one setting in the vehicle based on the received third, fourth, fifth, and sixth commands.
   In some embodiments, there may be a conflict in the commands. One may take precedence over the other.
   FG.2 The vehicle of embodiment FG in which the processor is further operable to:

determine that there is a conflict between two of the received commands; and

determine a highest priority command from among the conflicting commands,

in which, in issuing instructions, the processor is operable to effectuate at least one setting in the vehicle based only on the highest priority command from among the conflicting commands.

In some embodiments, a mute button or explicit indication by the user may point to which commands have highest priority.
FG.2.1 The vehicle of embodiment FG.2 in which the processor is further operable to receive from the user an indication to reduce the priority of any commands received via a particular sensor,

in which, in determining a highest priority command, the processor is operable to determine a command from among the conflicting commands that has not been received via the particular sensor.

FG.2.1.1 The vehicle of embodiment FG.2.1 in which the processor is further operable to receive from the user an indication to mute the microphone,

in which, in determining a highest priority command, the processor is operable to determine a command from among the conflicting commands that has not been received via the microphone.

In some embodiments, external conditions may dictate which commands are followed. For example, touch screen display may be disabled if there are bad road conditions and it would be dangerous for the user to take his eyes off the road to touch the screen.
FG.2.2 The vehicle of embodiment FG.2 in which the processor is further operable to:

receive an indication of current driving conditions; and

determine, based on the indication of current driving conditions, that any commands received via a particular sensor will have reduced priority,

in which, in determining a highest priority command, the processor is operable to determine a command from among the conflicting commands that has not been received via the particular sensor.

FG.2.2.1 The vehicle of embodiment FG.2 in which, in receiving an indication of current driving conditions, the processor is operable to receive an indication of poor visibility, and in which the particular sensor is the display screen that is touch sensitive.
In some embodiments, the vehicle may determine gestured commands through gesture-recognition algorithms performed on captured video.
FG.1 The vehicle of embodiment F in which, in receiving the second gestured command, the processor is operable to:

receive a video of the user captured by the camera;

determine the second gestured command by performing a gesture-recognition algorithm on the video.
In some embodiments, a manufacturer may receive live updates from a vehicle in use. The manufacturer may thereupon provide performance optimizing inputs to the vehicle.
H. A system comprising a vehicle and a remote server,

in which the vehicle is operable to:
determine a first operational state of the vehicle;
transmit to the remote server an indication of the first operational state;
receive from the remote server an indication of a suggested second operational state for the vehicle; and
effectuate the second operational state, and

in which the remote server is operable to:
receive from the vehicle an indication of the first operational state;
determine a second operational state that would improve performance of the vehicle; and
transmit an indication of the second operational state to the vehicle.
   H.1 The system of embodiment H in which the first operational state includes one of: (a) an engine speed; (b) a driving speed; (c) a power distribution among wheels of the vehicle; (d) a gear; (e) percentage use of a gas-powered engine; and (f) a percentage use of an electric engine.
   H.2 The system of embodiment H,

in which the vehicle is further operable to:
determine an environmental state; and
transmit the environmental state to the remote server, and

in which the remove server, in determining the second operation state, is operable to determine the second operational state based on the environmental state.

H.3 The system of embodiment H.2 in which the environmental state includes one of: (a) a weather condition; (b) a road condition; (c) a presence of potholes (d) a traffic condition; (e) a location; (f) an altitude; (g) a road incline; and (h) a road curvature.
In some embodiments, a vehicle may direct audio to the location of a given user, whether the user is a driver or passenger.
I. A vehicle comprising:

a sensor;

a speaker system;

a control system operable to receive electronic signals and actuate systems of the vehicle based on the received electronic signals;

a computer readable medium containing computer code;

a processor operable to execute the computer code to:
determine a first location of a first user within the vehicle; and
issue instructions to the speaker system to optimize a first audio presentation for the first location.
   I.5 The vehicle of embodiment I, further comprising a headphone jack, in which the processor is further operable to transmit a second audio presentation to a second user via the headphone jack.
   I.5.1 The vehicle of embodiment I.5, in which the first audio presentation and second audio presentation are presented simultaneously.
   I.6 The vehicle of embodiment I in which the audio presentation is one of: (a) a song; (b) a radio program; (c) a soundtrack; (d) an audio book; (e) a set of driving instructions; (f) a set of instructions; (g) a live phone conversation; and (h) a voicemail.
   I.1 The vehicle of embodiment I in which, in executing the computer code, the processor is further operable to:

determine a second location of a second user within the vehicle;

issue instructions to the speaker system to optimize a second audio presentation for the second location.

In some embodiments, the same speaker system can simultaneously output two different audio tracks to two different people.
I.1.1 The vehicle of embodiment I.1 in which the speaker system is operable to:

simultaneously output both the first and second audio presentations.

I.2 The vehicle of embodiment I in which, in optimizing the first audio presentation, the speaker system is operable to:

coordinate the delays of each of a plurality of speakers within the speaker system.

I.3 The vehicle of embodiment I in which, in optimizing the first audio presentation, the speaker system is operable to:

coordinate the volumes of each of a plurality of speakers within the speaker system.

I.4 The vehicle of embodiment I in which, in determining the first location of the first user, the processor is further operable to:

receive a biometric indicator of the first user via the sensor; and

determine the first location based on the biometric indicator.

I.4.1 The vehicle of embodiment I.4 in which the biometric indicator is a voice recording.
In some embodiments, multiple vehicles can share information, such as road conditions, and so on.
J. A vehicle comprising:

a sensor;

a control system operable to receive electronic signals and actuate systems of the vehicle based on the received electronic signals;

a computer readable medium containing computer code;

a processor operable to execute the computer code to:
receive a reading from the sensor;
determine, based on the reading, a condition of a road; and
transmit to a second vehicle an indication of the condition of the road.
   J.1 The vehicle of embodiment J in which the sensor is a motion sensor and the condition of the road includes a presence of potholes.
   J.2 The vehicle of embodiment J in which the sensor is a camera sensor and the condition of the road includes a presence of obstacles on the road.
   In some embodiments, information is shared only with other vehicles nearby.
   J.3 The vehicle of embodiment J in which, in transmitting to the second vehicle, the processor is further operable to:

determine a second vehicle that is nearby; and

transmit to the second vehicle an indication of the condition of the road.

In some embodiments, information is shared only with other vehicles within a social network or social circle.
J.4 The vehicle of embodiment J in which, in transmitting to the second vehicle, the processor is further operable to:

determine a second vehicle that belongs to a same group as does the first vehicle; and

transmit to the second vehicle an indication of the condition of the road.

J.4.1 The vehicle of embodiment J.4 in which the group is a social network.
In some embodiments, a central server or service receives information from some vehicles and transmits the info to other vehicles. Exemplary information may include weather, traffic conditions, and road conditions.
K. A method comprising:

receiving from a first vehicle an indication of a first location;

receiving from the first vehicle an indication of a driving condition;

receiving from a second vehicle an indication of a second location;

determining that the second vehicle is in the vicinity of the first vehicle; and

transmitting to the second vehicle an indication of the driving condition.

K.1 The method of embodiment K in which the driving condition is one of: (a) a weather condition; (b) a traffic condition; (c) a road condition; (d) a road incline; (e) a road curvature; (f) an altitude; (g) a traffic speed; and (h) a temperature.
In some embodiments, a central server or service receives communications from some vehicles and transmits the communication to other vehicles. The sending and recipient vehicles may be members of the same group or social network, for example.
L. A method comprising:

receiving from a first vehicle an indication of a recipient group;

receiving from the first vehicle an indication of a message;

determining a second vehicle falling within the recipient group; and

transmitting the message to the second vehicle.

In some embodiments, a vehicle on a wireless network may be part of a wireless voice call. The call may include a voice over internet protocol (VOIP) call. In some embodiments, as the vehicle moves from within one wireless network to another, the call may be handed off from one network to the other.
M. A vehicle comprising:

a sensor;

a first antenna;

a control system operable to receive electronic signals and actuate systems of the vehicle based on the received electronic signals;

a computer readable medium containing computer code;

a processor operable to execute the computer code to:
initiate a first wireless connection over a first wireless network via the first antenna, in which the first wireless connection supports a voice call;
receive first voice data through the first wireless network;
transmit second voice data through the first wireless network;
detect the availability of a second wireless network;
initiate a second wireless connection over the second wireless network, in which the second wireless connection also supports the same voice call;
terminate the first wireless connection once the second wireless connection has been initiated;
receive third voice data through the second wireless network; and
transmit fourth voice data through the second wireless network.
   M.1 The vehicle of embodiment M in which the second wireless connection is initiated via the first antenna.
   M.2 The vehicle of embodiment M further comprising a second antenna, in which the second wireless connection is initiated via the second antenna.
   M.3 The vehicle of embodiment M in which, in executing the computer code, the processor is further operable to determine, prior to initiating the second wireless connection, that the second wireless connection would provide superior performance to the first wireless connection.
   M.4 The vehicle of embodiment M in which the first wireless network is one of a: (a) 3G network; (b) Wi-Fi network; (c) WiMAX network; and (d) cellular network.
   In some embodiments, when vehicles are in range of one another, a communication between them can be initiated.
   N. A vehicle comprising:

a sensor;

a first antenna;

a control system operable to receive electronic signals and actuate systems of the vehicle based on the received electronic signals;

a computer readable medium containing computer code;

a processor operable to execute the computer code to:
receive an indication that a second vehicle is within communication range;
transmit, via the first antenna, a first communication to the second vehicle; and
receive, via the first antenna, a second communication from the second vehicle.
   N.1 The vehicle of embodiment N in which, in executing the computer code, the processor is further operable to:

determine, prior to the transmission of the first communication, that the second vehicle is one of a predetermined group of vehicles.

N.1.1 The vehicle of embodiment N in which the predetermined group of vehicles constitutes a contact list of vehicles.
N.2 The vehicle of embodiment N in which the indication is received from a central server.
N.3 The vehicle of embodiment N in which, in executing the computer code, the processor is further operable to:

receive the first communication from a first occupant via a microphone; and

instruct a speaker to broadcast the second communication within the vehicle.

In some embodiments, operating parameters of the vehicle are controlled by a central server. For example, the vehicle may be a police vehicle. If the server determines that the vehicle is to give chase, then the server may automatically activate sirens and turn off distractions within the vehicle, such as music.
O. A vehicle comprising:

a sensor;

an antenna;

a control system operable to receive electronic signals and actuate systems of the vehicle based on the received electronic signals;

a computer readable medium containing computer code;

a processor operable to execute the computer code to:
transmit via the antenna an indication of the vehicle's location to a central server;
transmit via the antenna an indication of an operating parameter of the vehicle;
receive via the antenna, a command to modify the operating parameter of the vehicle; and
modify the operating parameter of the vehicle based on the received command.
   O.1 The vehicle of embodiment O, in which, in executing the computer code, the processor is further operable to:

receive via the antenna, an image from the central server; and

instruct a display screen to display the image.

O.1.1 The vehicle of embodiment O.1 in which the image depicts a map with a driving route.
O.1.2 The vehicle of embodiment O.1 in which the image depicts a criminal suspect.
O.2 The vehicle of embodiment O in which the operating parameter is an audio presentation that is being broadcast within the vehicle, and in which the command to modify the operating parameter includes a command to terminate the audio presentation.
O.3 The vehicle of embodiment O in which the operating parameter is a driving speed of the vehicle, and in which the command to modify the operating parameter includes a command to increase the driving speed.
O.4 The vehicle of embodiment O in which the operating parameter is an activation state of a siren of the vehicle, and in which the command to modify the operating parameter includes a command to switch the siren from inactive to active.
P. A vehicle comprising:

a sensor;

an antenna;

a control system operable to receive electronic signals and actuate systems of the vehicle based on the received electronic signals;

a computer readable medium containing computer code;

a processor operable to execute the computer code to:
transmit via the antenna an indication of the vehicle's location to a central server;
transmit via the antenna an indication of an operating parameter of the vehicle;
receive via the antenna, a command to modify the operating parameter of the vehicle;
receive information available in the vehicle;
receive data;
determine processed information by combining the information available in the vehicle and the data received;
relay processed information to the user; and
modify the operating parameter of the vehicle based on the received command.
   P.1 The vehicle of embodiment P, in which, in executing the computer code, the processor is further operable to:

receive via the antenna, an image from the central server; and

instruct a display screen to display the image.

P.1.1 The vehicle of embodiment P.1 in which the image includes map data, in which the processor is further operable to:

determine a destination;

determine directions to the destination;

cause the map data to be projected on the display screen; and

cause the directions to be displayed overlayed on top of the map data on the display screen.

P.1.1.1 The vehicle of embodiment P.1.1 in which received information includes a camera feed from a camera installed in the vehicle, and in which the processor is further operable to cause the camera feed to be displayed together with the map and directions on the display screen.
P.1.2 The vehicle of embodiment P.1 in which the image depicts a map with a driving route.
P.1.3 The vehicle of embodiment P.1 in which the image depicts a criminal suspect.
P.2 The vehicle of embodiment P in which the operating parameter is an audio presentation that is being broadcast within the vehicle, and in which the command to modify the operating parameter includes a command to terminate the audio presentation.
P.3 The vehicle of embodiment P in which the operating parameter is a driving speed of the vehicle, and in which the command to modify the operating parameter includes a command to increase the driving speed.
P.4 The vehicle of embodiment P in which the operating parameter is an activation state of a piece of equipment of the vehicle, and in which the command to modify the operating parameter includes one of: (a) a command to switch the piece of equipment from inactive to active; and (b) a command to activate a specific function of the piece of equipment.
While example embodiments have been illustrated and described, it will be clear that additional embodiments are contemplated. Numerous modifications, changes, variations, substitutions and equivalents will be apparent to those skilled in the art without departing from the spirit and scope of the described and contemplated embodiments.

1. A vehicle comprising:
a sensor;
a control system operable to receive electronic signals and actuate systems of the vehicle based on the received electronic signals;
a computer readable medium containing computer code;
a processor operable to execute the computer code to:
receive first information about a first user in the vehicle;
determine a first identity of the first user based on the received first information;
determine a first setting associated with the first identity, in which the first setting is a setting of a system of the vehicle; and
issue instructions to effectuate the first setting in the vehicle.

2. The vehicle of claim 1 in which the processor is further operable to:
receive from the first user an indication of a desire to enter a transaction with a counterparty;
receive from a counterparty a request to confirm the first identity of the first user; and
provide to the counterparty an indication that the first identity has been confirmed based on the first information.

3. The vehicle of claim 2 in which the processor is further operable to:
provide to the first user an indication that the counterparty has agreed to the transaction; and
provide to the counterparty an indication that the first user has agreed to the transaction.

4. The vehicle of claim 1, in which the processor is further operable to receive an indication of a set of preferences associated with the first user, in which the first setting is included among the set of preferences.

5. The vehicle of claim 1 in which the set of preferences is received from another vehicle.

6. The vehicle of claim 1 in which the set of preferences is received over a network.

7. The vehicle of claim 1 in which the set of preferences is received from an external device.

8. The vehicle of claim 1 in which the set of preferences is received from a mobile communications device.

9. The vehicle of claim 1 in which the processor is further operable to:
receive second information about a second user in the vehicle;
determine a second identity of the second user based on the received second information;
determine a second setting associated with the second identity, in which the second setting is a setting of a system of the vehicle; and
issue instructions to effectuate the second setting in the vehicle.

10. The vehicle of claim 9 in which the first setting is not the same as the second setting.

11. The vehicle of claim 1 in which, in receiving first information about the first user, the processor is operable to receive biometric information about the first user.

12. The vehicle of claim 11 in which the biometric information includes one of: (a) a fingerprint reading; (b) a picture; (c) a retinal scan; (d) a voice recording; (e) a weight; (f) a height; (g) an eye color; and (h) a hair color.

13. The vehicle of claim 1 further including a climate control system, in which the first setting is a temperature, and in which, in issuing instructions, the processor is operable to issue instructions for the climate control system to bring the interior of the vehicle to the temperature.

14. The vehicle of claim 1 further including a radio, in which the first setting is a music player, and in which, in issuing instructions, the processor is operable to issue instructions for the songs to play according to the known profile of the user.

15. The vehicle of claim 1 further including a seat, in which the first setting is a seat position, and in which, in issuing instructions, the processor is operable to issue instructions for the seat to move to the seat position.

16. A vehicle comprising:
a first sensor proximate to a driver's seat;
a second sensor proximate to a passenger's seat;
a control system operable to receive electronic signals and actuate systems of the vehicle based on the received electronic signals;
a computer readable medium containing computer code;
a processor operable to execute the computer code to:
receive a first command from the driver via the first sensor;
receive a second command from the passenger via the second sensor; and
issue instructions to effectuate a first setting in the vehicle based on the received first command; and
issue instructions to effectuate a second setting in the vehicle based on the received second command.

17. The vehicle of claim 16 in which the first sensor is a first microphone, and the second sensor is a second microphone.

18. The vehicle of claim 16 in which the first sensor is a first camera, and the second sensor is a second camera.

19. The vehicle of claim 16 in which the processor is further operable to execute computer code to:
receive a third command from the passenger via the first sensor;
determine that the third command has not originated from the driver; and
disregard the third command based on the determination that it did not originate from the driver.

20. The vehicle of claim 19 in which, in determining that the third command has not originated from the driver, the processor is operable to determine that audio constituting the third command has originated from a source not proximate to the first sensor.

21. The vehicle of claim 19 in which, in determining that the third command has not originated from the driver, the processor is operable to:
load a voice profile of the driver;
compare audio constituting the third command to the voice profile; and
determine that the audio does not match the voice profile.
determine the location source of the sound using sensors.

22. The vehicle of claim 16 in which the first and second commands are received substantially simultaneously to effectuate settings which are processed.

23. The vehicle of claim 16 further including:
a third sensor comprising a microphone;
a fourth sensor comprising a camera;
a fifth sensor comprising a display screen that is touch sensitive; and
a steering wheel with a sixth sensor comprising a touch pad,
in which, in executing the computer code, the processor is further operable to:
receive a third spoken command from a user via the microphone;
receive a fourth gestured command from the user via the camera;
receive a fifth command from the user via the display screen that is touch sensitive;
receive a sixth command from the user via the touch pad; and
issue instructions to effectuate at least one setting in the vehicle based on the received third, fourth, fifth, and sixth commands.

24. The vehicle of claim 23 in which the processor is further operable to:
determine that there is a conflict between two of the received commands; and
determine a highest priority command from among the conflicting commands,
in which, in issuing instructions, the processor is operable to effectuate at least one setting in the vehicle based only on the highest priority command from among the conflicting commands.

25. The vehicle of claim 24 in which the processor is further operable to receive from the user an indication to reduce the priority of any commands received via a particular sensor,
in which, in determining a highest priority command, the processor is operable to determine a command from among the conflicting commands that has not been received via the particular sensor.

26. The vehicle of claim 25 in which the processor is further operable to receive from the user an indication to mute the microphone,
in which, in determining a highest priority command, the processor is operable to determine a command from among the conflicting commands that has not been received via the microphone.

27. The vehicle of claim 24 in which the processor is further operable to:
receive an indication of current driving conditions; and
determine, based on the indication of current driving conditions, that any commands received via a particular sensor will have reduced priority,
in which, in determining a highest priority command, the processor is operable to determine a command from among the conflicting commands that has not been received via the particular sensor.

28. The vehicle of claim 23 in which, in receiving the second gestured command, the processor is operable to:
receive a video of the user captured by the camera;
determine the second gestured command by performing a gesture-recognition algorithm on the video.

29. A system comprising a vehicle and a remote server,
in which the vehicle is operable to:
determine a first operational state of the vehicle;
transmit to the remote server an indication of the first operational state;
receive from the remote server an indication of a suggested second operational state for the vehicle; and
effectuate the second operational state, and in which the remote server is operable to:
receive from the vehicle an indication of the first operational state;
determine a second operational state that would improve performance of the vehicle; and
transmit an indication of the second operational state to the vehicle.

30. The system of claim 29 in which the first operational state includes one of: (a) an engine speed; (b) a driving speed; (c) a power distribution among wheels of the vehicle; (d) a gear; (e) percentage use of a gas-powered engine; and (f) a percentage use of an electric engine.

31. The system of claim 29,
in which the vehicle is further operable to:
determine an environmental state; and
transmit the environmental state to the remote server, and
in which the remove server, in determining the second operation state, is operable to determine the second operational state based on the environmental state.

32. The system of claim 31 in which the environmental state includes one of: (a) a weather condition; (b) a road condition; (c) a presence of potholes (d) a traffic condition; (e) a location; (f) an altitude; (g) a road incline; and (h) a road curvature.

33. A vehicle comprising:
a sensor;
a speaker system;
a control system operable to receive electronic signals and actuate systems of the vehicle based on the received electronic signals;
a computer readable medium containing computer code;
a processor operable to execute the computer code to:
determine a first location of a first user within the vehicle; and
issue instructions to the speaker system to optimize a first audio presentation for the first location.

34. The vehicle of claim 33, further comprising a headphone jack, in which the processor is further operable to transmit a second audio presentation to a second user via the headphone jack or set of speakers near to him.

35. The vehicle of claim 34, in which the first audio presentation and second audio presentation are presented simultaneously.

36. The vehicle of claim 33 in which the audio presentation is one of: (a) a song; (b) a radio program; (c) a soundtrack; (d) an audio book; (e) a set of driving instructions; (f) a set of instructions; (g) a live phone conversation; and (h) a voicemail.

37. The vehicle of claim 33 in which, in executing the computer code, the processor is further operable to:
determine a second location of a second user within the vehicle;
issue instructions to the speaker system to optimize a second audio presentation for the second location.

38. The vehicle of claim 37 in which the speaker system is operable to:
simultaneously output both the first and second audio presentations.

39. The vehicle of claim 33 in which, in optimizing the first audio presentation, the speaker system is operable to:
coordinate the delays of each of a plurality of speakers within the speaker system;
coordinate the volumes of each of a plurality of speakers within the speaker system; and
transmitting cancelling sound signals to reduce the component of interference of presentations given to different users.

40. The vehicle of claim 33 in which, in determining the first location of the first user, the processor is further operable to:
receive a biometric indicator of the first user via the sensor; and
determine the first location based on the biometric indicator.

41. The vehicle of claim 40 in which the biometric indicator is a voice recording.

42. A vehicle comprising:
a sensor;
a control system operable to receive electronic signals and actuate systems of the vehicle based on the received electronic signals;
a computer readable medium containing computer code;
a processor operable to execute the computer code to:
receive a reading from the sensors;
determine, based on the reading, a condition of a road; and
transmit to a second vehicle an indication of the condition of the road.

43. The vehicle of claim 42 in which the sensor is a motion sensor and the condition of the road includes a presence of potholes.

44. The vehicle of claim 42 in which the sensor is a camera sensor and the condition of the road includes a presence of obstacles on the road.

45. The vehicle of claim 42 in which, in transmitting to the second vehicle, the processor is further operable to:
determine a second vehicle that is nearby; and
transmit to the second vehicle an indication of the condition of the road.

46. The vehicle of claim 42 in which, in transmitting to the second vehicle, the processor is further operable to:
determine a second vehicle that belongs to a same group as does the first vehicle; and
transmit to the second vehicle an indication of the condition of the road.

47. The vehicle of claim 46 in which the group is a social network.

48. A vehicle comprising:
a sensor;
an antenna;
a control system operable to receive electronic signals and actuate systems of the vehicle based on the received electronic signals;
a computer readable medium containing computer code;
a processor operable to execute the computer code to:
transmit via the antenna an indication of the vehicle's location to a central server;
transmit via the antenna an indication of an operating parameter of the vehicle;
receive via the antenna, a command to modify the operating parameter of the vehicle;
receive information available in the vehicle;
receive data;
determine processed information by combining the information available in the vehicle and the data received;
relay processed information to the user; and
modify the operating parameter of the vehicle based on the received command.

49. The vehicle of claim 48, in which, in executing the computer code, the processor is further operable to:
receive via the antenna, an image from the central server; and
instruct a display screen to display the image.

50. The vehicle of claim 49 in which the image includes map data, in which the processor is further operable to:
determine a destination;
determine directions to the destination;
cause the map data to be projected on the display screen; and
cause the directions to be displayed overlayed on top of the map data on the display screen.

51. The vehicle of claim 50 in which received information includes a camera feed from a camera installed in the vehicle, and in which the processor is further operable to cause the camera feed to be displayed together with the map and directions on the display screen.

52. The vehicle of claim 49 in which the image depicts a map with a driving route.

53. The vehicle of claim 48 in which the operating parameter is a driving speed of the vehicle, and in which the command to modify the operating parameter includes a command to decrease the driving speed.

54. The vehicle of claim 48 in which the operating parameter is an activation state of a piece of equipment of the vehicle, and in which the command to modify the operating parameter includes one of: (a) a command to switch the piece of equipment from inactive to active; and (b) a command to activate a specific function of the piece of equipment.
